(19) United States
(12) Patent Application Publication
(10) Pub. No.: US 2024/0256421 A1
(43) Pub. Date: Aug. 1, 2024

(54) Log Data Summarization Techniques

(71) Applicant: Salesforce, Inc., San Francisco, CA (US)

(72) Inventor: Joshua David Alexander, Austin, TX (US)

(21) Appl. No.: 18/162,445

(22) Filed: Jan. 31, 2023

(51) Int. Cl. G06F 11/34

(52) U.S. Cl. CPC G06F 11/3476

(57) ABSTRACT

The disclosed techniques include the generation of a summary event log from multiple event logs that are identical. Event logs may be identical when the event logs include the same action by the same user using the same source. In various instances, multiple event logs accumulated over a predetermined period of time are summarized in the summary event log. The summary event log includes the information that is identical among the multiple event logs along with additional information about the time period the event logs are accumulated, the number of events that are identical, and memory usage by the event logs. Other information may also be annotated to the summary event log as necessary.

### BACKGROUND

### Technical Field

This disclosure relates to electronic event log transmission, in particular, to techniques for accessing and summarizing event logs generated by software and hardware systems (e.g., enterprise systems having associated software and hardware).

### Description of the Related Art

Computer systems may include multiple computers, workstations, servers, and storage systems, each performing different tasks. When tasks are performed, the end result is often referred to as an event (e.g., an action or occurrence associated with the computer system). Various software associated with computer systems create event logs for any significant events that are recognized by the software. Events recognized by software can originate from any type of hardware or software associated with the computer system. For instance, events can originate from operating systems, networks, servers, firewalls, communication software, antivirus software, messaging software, meeting software, database queries, hardware infrastructure, etc.

Event logs are stored by the software in the computer system (either in memory or another cache) and accessible by various entities as needed. In many instances, security tools, such as SIEM (Security Information and Event Management) tools, utilize event log data to analyze the events occurring in a computer system and determine whether there are any potential issues with the computer system. For instance, a SIEM tool can analyze event log data to determine whether there are any anomalies in the events occurring that might indicate a security issue with the computer system. SIEM tools are generally used to monitor all event logs created by computer systems. With the ever increasing amounts of event log data generated, however, various adjustments have been made in how SIEM tools are applied to event log data. Other entities that may access event log data include, but are not limited to, information technology tools or development tools.

### BRIEF DESCRIPTION OF THE DRAWINGS

FIG. 1 is a block diagram of an example system configured to summarize event log data within an enterprise system, according to some embodiments.

FIG. 2 depicts a table showing example event log data accumulated over a predetermined time period.

FIG. 3 is a block diagram of a summary log generation module, according to some embodiments.

FIG. 4 is a block diagram depicting an example analysis tool module, according to some embodiments.

FIG. 5 is a flow diagram depicting an example method for generating a summary log entry for event logs recorded in an enterprise system, according to some embodiments.

FIG. 6 is a block diagram illustrating elements of a multi-tenant system, according to some embodiments.

FIG. 7 is a block diagram illustrating elements of a computer system configured to implement various systems described in the present disclosure, according to some embodiments.

### DETAILED DESCRIPTION OF EMBODIMENTS

Computer systems, whether single desktop/laptop computer systems with a single user or networked systems with multiple users, create logs to record events that are recognized by software running on the computer systems. As used herein, the term “event” is intended to be construed according to its well-understood meaning in computer terms, which includes any significant action or occurrence that is recognized by software operating on a computer system. Events can be hardware or software events as long as software can recognize and determine information about an event. Examples of events include, but are not limited to, actions or occurrences originating from operating systems, networks, servers, firewalls, communication software, antivirus software, messaging software, meeting software, virtual private networking software, database queries, hardware infrastructure.

Events are typically recorded in files call “event logs” or “event log data”. Event logs generally provide a list of events in chronological order along with information associated with each event. Information associated with events that may be provided in event logs includes, but is not limited to, date and time of event, description of event (e.g., action or occurrence description), source of event (e.g., application or process involved with event), user associated with event (e.g., user initiating or triggering event), network information (e.g., IP address), hardware information (e.g., port address), severity of event, and specific code or other identifier associated with the event. An event log is typically stored in a memory or cache of the computer system with the event log being associated with the software creating the event recording. Typically, the operating system or software generating the event log continually writes to the same event log. A new event log may be started when a maximum file size threshold is reached or some time limit on the event log is reached.

Event logs provide information for various purposes. For instance, in certain instances, event logs may be accessed when a problem or incident occurs with a computer system. Analysis of the event logs may allow for determination of the cause of the problem or incident as well as the source of the incident (e.g., hardware or software). Examples of causes of problems or incidents include, but are not limited to, hardware faults, operating system errors, security breaches, application failures, or performance degradation.

In certain instances, event logs are accessed in real-time to provide real-time visibility of events occurring on a computer system. For instance, many enterprises employ security tools that continually access event logs to provide real-time security monitoring of computer systems within the enterprise. Real-time security monitoring may provide increased security for the enterprise and enable more rapid security response than is available with “after the fact” analysis of event logs. SIEM (Security Information and Event Management) tools are one specific example of security tools that continually access event logs to provide real-time visibility across an enterprise system or other organizational system. SIEM tools are typically used to analyze event logs for an enterprise to determine whether there are any anomalies in events occurring on the computer systems operating in the enterprise. Anomalies may be indicators of abnormal activity such as malicious attempts being made to access or otherwise manipulate the systems within the enterprise.

As computer system usage constantly increases, the amount of event log data is constantly increasing at exponential rates. While SIEM tools (and other event log analysis tools) are being incrementally made more efficient, the exponential increase in event log data can increase the costs to run these tools (both processing and monetary) and outweigh the benefits of using the tools on a normal basis. Performance degradation in SIEM tools may also occur when the information provided to SIEM tools overwhelms the available computation resources. To compensate for the increases in costs and performance degradation, many enterprises choose to arbitrarily remove some event log data from implementation in these tools or run the tools less frequently. For instance, an enterprise may choose to run a SIEM tool on only a portion of event log data collected over a time period or may only run the SIEM tool on event log data once every 30 days instead of in real-time.

These compensation mechanisms, however, may create security holes in processing by SIEM tools that malicious actors can exploit. For instance, if the SIEM tool is only run once every 30 days, security issues may not be detected until it is too late. In other instances, if the amount of event log data processed is arbitrarily reduced, then the SIEM tool may have more “noise” in its processing. For example, the SIEM tool may not be able to accurately determine normal background patterns to differentiate abnormal behavior, which can cause abnormal events to be missed in the noise.

Due to the vast amount of event log data available from computer systems, the disclosed techniques include reducing the amount of event log data to be processed by SIEM tools (or other analysis tools) while maintaining the information available in the data (e.g., minimizing the loss of event log data that is processed by the SIEM tools). In various embodiments, a single (summary) event log is created to represent multiple event logs based on similarities in the actions (e.g., occurrences) and other parameters (e.g., event source, user, etc.) in the multiple event logs. For instance, in certain embodiments, a summary log that represents multiple event logs is created when multiple event logs have the same user doing the same action from the same source during a specified time period. The summary log may be provided to the SIEM tool (or other analysis tool) as a single entry that represents multiple event logs with the same characteristics. Providing the summary log instead of the multiple event logs reduces the amount of data provided to the analysis tool while maintaining the information provided to the analysis tool.

In various embodiments, additional data is added to the summary log to provide more information about the multiple event logs the summary log is replacing. For instance, event logs typically have date and time stamps. While the summary log may not provide specific date and time stamps, a time period (and date) that the summary log covers may be added as an entry in the summary log. Additionally, an entry may be made for the number of events (e.g., incidences) being replaced by the summary log. As an example, if user A logs in and checks their email 35 times over a one hour time period between 8:00 am and 9:00 am on January 10^{th}, a summary log may indicate that user A logged into their email 35 times over the time period of 8:00 am to 9:00 am on January 10^{th}. In some embodiments, a summary log may also include an indication of the size of the individual logs (e.g., user A logged into their email 35 times over one hour with 10 kb per event log). Thus, instead of 35 separate log files (at 10 kb each for a total of about 350 kb), a summary log at a total of about 10 kb represents the events over the specified time period with a single log entry (e.g., a single log file). Different summary logs may be created for combinations of different actions, different users, different sources, or different time periods. For instance, separate summary logs are needed if any one of an action, a user, or a source is different over a specified time period. Simple mathematical models or more involved machine learning models (e.g., neural networks or rules-based algorithms) may be implemented to create summary logs.

After creation of summary logs according to the disclosed techniques, the summary logs may be analyzed by a SIEM tool or other analysis tool. As described herein, the SIEM tool may determine whether there are any anomalies in the event log data. In various embodiments, the SIEM tool may be programmed (e.g., trained) to process summary log data instead of event log data. Thus, for a specified time period, multiple summary logs representing event logs over the specified time period may be provided to the SIEM tool. The SIEM tool will process the summary logs to determine whether any event anomalies occurred over the specified time period. Since the summary logs provide a more concise representation of the actual event logs accrued over the specified time period, the SIEM too can process the information more quickly. Additionally, as the summary logs minimize the loss of event log data from the event logs (e.g., no event is arbitrarily removed or skipped over in the summary logs), the SIEM tool is able to fully process the events over the specified time period and provide more accurate analysis of the events (and prevent security holes that can be exploited from appearing). Accordingly, certain embodiments are contemplated where the disclosed techniques provide capability for real-time monitoring using a SIEM tool for computer systems that produce large amounts of event log data.

As used herein, the term “enterprise system” is intended to be construed according to its well-understood meaning, which includes a set of large-scale software packages that track and control complex operations of one or more entities. For example, an enterprise system may track and control complex operations for businesses that provide services such as customer relationship management (CRM), enterprise resource planning (ERP), supply chain management (SCM), etc. As used herein, the term “entity” refers to a user or a collection of users (e.g., an organization or an enterprise). As used herein, the term “enterprise software” is broadly defined to cover both downloadable “enterprise software” and software accessible via the internet and hosted by a third-party provider (which may be referred to as software-as-a-service (SaaS)). As noted above, an “enterprise system” may be a collection of “enterprise software”. In context of claims and specification, an instance of enterprise software serves as a “source” for event data logs. Example enterprise software includes email software, messaging software, meetings software, search software, operating system software, networking software, etc. (e.g., any software that creates event log data). In addition to enterprise software, enterprise hardware (e.g., computer systems, hard drives, servers, cameras, printers, network devices, etc.) may also be a source for event data logs, though the software associated with such hardware is responsible for generating and storing the event data logs.

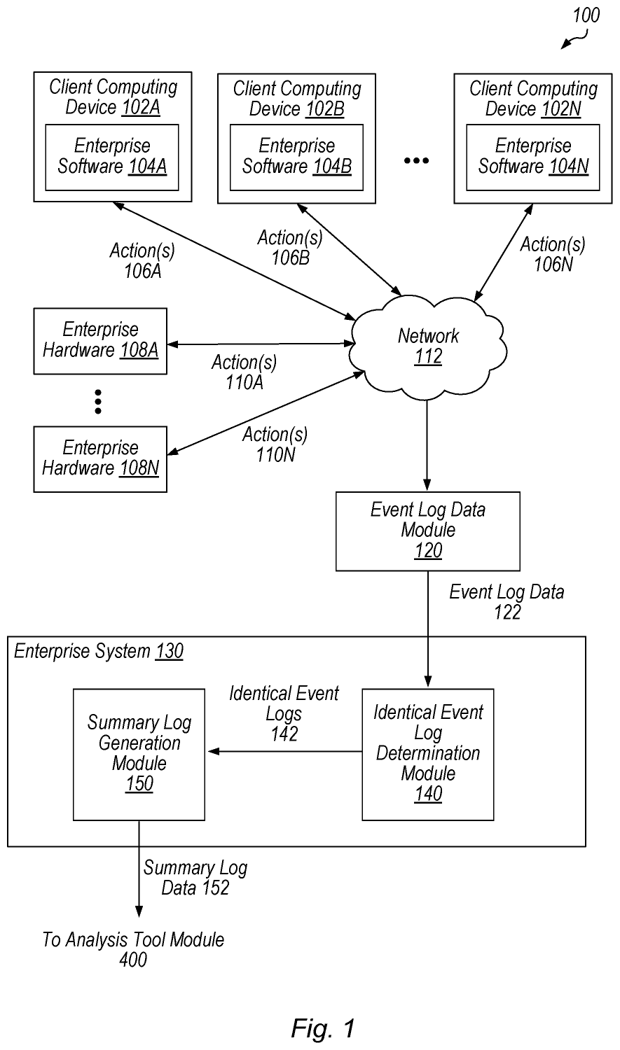

In various embodiments, the disclosed techniques may advantageously reduce or remove shadows or holes in processing of high volumes of event log data by security tools, such as SIEM tools, or other analysis tools. Similarly, the disclosed techniques may advantageously increase computation efficiency for these analysis tools by reducing the amount of log data to be processed. Further, reducing the amount of log data to be processed can reduce costs associated with processing of data for an enterprise or enterprise system when data processing costs are determined on the size of data being processed. The disclosed techniques provide these advantages while minimizing the loss of event log data. Accordingly, improvements in security and other analysis of operations of enterprise systems are improved. An exemplary application of these techniques will now be discussed, starting with reference to FIG. 1.

### Example Networked Enterprise System

FIG. 1 is a block diagram of an example system configured to summarize event log data within an enterprise system, according to some embodiments. Within system 100, network 112 may represent the Internet, an intranet, or any other suitable type of computer network. Network 112 may couple one or more client computing devices 102A-102N to enterprise hardware 108A-108N, event log data module 120, and enterprise system 130. Client computing devices 102A, 102B, through 102N includes enterprise software 104A, 104B, through 104N. Client computing devices may also be referred to user computing devices herein. The enterprise software 104A-104N may include various types of software that can be downloaded on the client computing devices 102A-102N. Examples of software include, but are not limited to, operating system software, communication software (e.g., messaging software or meeting software), networking software, antivirus software, virtual private networking software, and database query software. Enterprise hardware 108A-108N may also be coupled to network 112. Enterprise hardware 108A-108N may include any hardware shared by system 100 (e.g., hardware shared by client computing devices 102A-102N). Hardware may also be included in client computing devices 102A-102N. Examples of hardware in system 100 include, but are not limited to, network devices, servers, printers, storage devices, cameras, keyboards, mice, power devices, etc.

System 100 is an enterprise system that includes event log data module 120 and enterprise system 130, which in turn includes identical event log determination module 140 and summary log generation module 150. Event log data module 120 may be, for example, a database module (which may also be referred to as a “database system” or “database computer system” or “database store”) or other module capable of event logging and event log data storage. In various embodiments, event log data module 120 is capable of storing event log data associated with actions by software or hardware in system 100. For example, as shown in FIG. 1, event log data module 120 may store event logs involving actions 106A-106N associated with client computing devices 102A-102N or actions 110A-110N associated with enterprise hardware 108A-108N. As used herein, the term “action” refers to any event associated with a computer system that is recognized by software in the computer system and for which an event log is generated. Any software or hardware in a computer system (e.g., any client computing device 102A-102N or enterprise hardware 108A-108N in system 100) can be a “source” for an action with the action recognized by software in the computer system. The software then generates event logs in response to recognizing the actions. In various embodiments, actions are performed by users (e.g., users of client computing devices 102A-102N) and event logs are generated in response to the user actions.

In certain embodiments, event log data module 120 receives event logs from software in system 100 and stores the event logs. For example, event log data module 120 may receive event logs from enterprise software 104A-104N on client computing devices 102A-102N or software associated with enterprise hardware 108A-108N. In some embodiments, software that generates event logs may be located in event log data module 120. For instance, event log data module 120 may include software that monitors events (e.g., actions 106 or 110) in system 100 and generates event logs for monitored events.

In the illustrated embodiment, enterprise system 130 accesses event log data 122 from event log data module 120. As mentioned above, event log data includes event logs recording event by any software or hardware in system 100. Accordingly, event log data 122 120 may include hundreds, thousands, millions, etc. of event logs associated with system 100. For example, a business executing via enterprise system 130 may have 70,000 employees for which event log data module 120 receives and stores event logs. The event log data includes various actions taken by users of devices 102A-102N, including actions taken via enterprise software 104A-104N along with actions performed by enterprise hardware 108A-108N. In some embodiments, enterprise system 130 is a server system that executes enterprise software locally to system 100 (e.g., Salesforce.com). In other embodiments, enterprise system 130 is a server executed via a cloud service (e.g., Amazon Web Services™) and is not necessarily limited to a local system such as Salesforce.com. Furthermore, as discussed above, in some situations, enterprise system 130 is executed as an SaaS system.

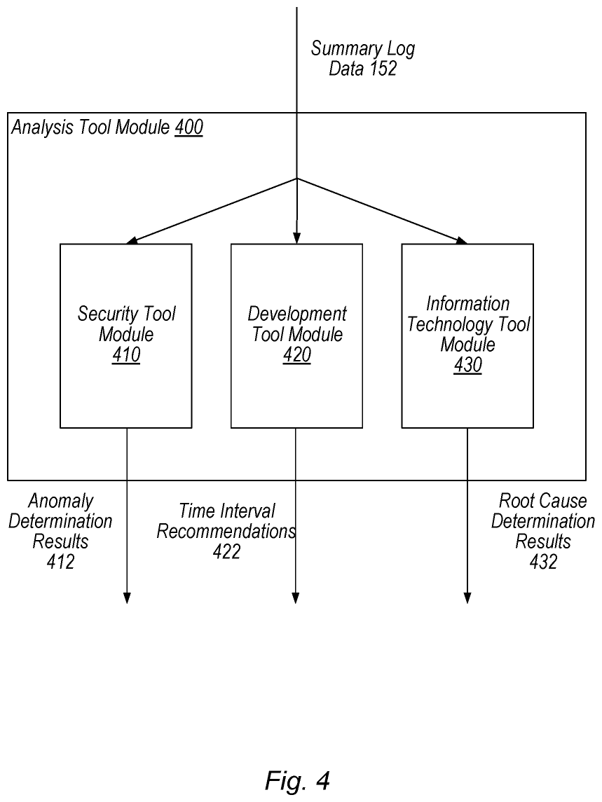

In various embodiments, enterprise system 130 accesses event log data 122 at predetermined time intervals. For instance, enterprise system 130 may access event log data at regular time intervals set by an administrator or other operator of system 100. In some embodiments, the time intervals may be set such that summary logs created from event logs accumulated over a time interval period have a specified memory size. The specified memory size may be, for example, a size that is readily processed by a downstream analysis tool (e.g., analysis tool module 400 described below with reference to FIG. 4). Some embodiments may be contemplated where enterprise system 130 accesses event log data 122 for a larger time interval (e.g., once a day) and then parses the event log data into shorter time intervals for generating summary logs (e.g., event logs are parsed into hour segments). Additional embodiments may be contemplated where the time intervals are not regular time intervals but rather a time interval is ended and event log data 122 is accessed when the event logs stored in event log data module 120 reach a predetermined memory size.

In the illustrated embodiment, enterprise system 130 executes identical event log determination module 140 to identify event logs in event log data 122 that identical over a predetermined time period. The predetermined time period may correspond to a time interval, as discussed above. In various embodiments, identical event log determination module 140 assesses event log data 122 to determine whether multiple event logs contain identical information during the predetermined time period. For instance, identical event log determination module 140 may determine whether values of parameters (e.g., values of characteristics) in the information in the event logs are identical. In certain embodiments, the determination of identical information is time-based, meaning that similarities or differences in information are determined for parameter values outside of the date and time of the event logs. Time (and date) are allowed to vary as it may be easiest to account for differences in values over time versus other parameters. While the embodiments disclosed herein use time as the parameter allowed to vary, additional methodologies could be developed where other parameters are allowed to have some differences that are accounted for while other parameters have to remain identical for the identification of identical event logs.

Determination of identical event logs may be based on evaluation of values of parameters in the event logs. Examples of parameters that may be assessed in a determination of identical event logs include, but are not limited to, action description (e.g., description of occurrence), source of event (e.g., software or hardware involved with event), user associated with event, network information (e.g., IP address), severity of event, and a specific identifier or code for the event (e.g., an error code). In various embodiments, event logs are determined to be identical only when the values for every parameter contained in the event logs (outside of time) are identical between the event logs. For instance, if event logs contain the four parameters—action, user, source, and identifier—then identical event logs must have the same values for all four parameters. Thus, any event logs that have one parameter value that is different between them (other than time) are not identical event logs.

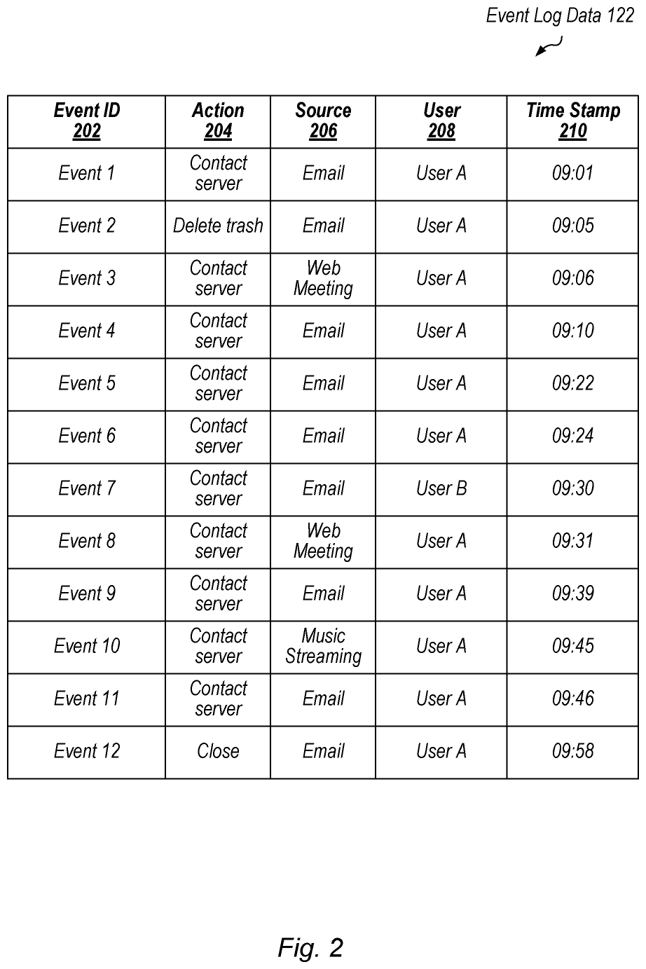

In certain embodiments, event logs are identified as being identical when the event logs have the same user doing the same action from the same source over the predetermined time period. Accordingly, event logs are only identified as being identical when the event logs have identical values for the user, identical values for the action, and identical values for the source. FIG. 2 depicts a table showing example event log data accumulated over a predetermined time period. Event ID 202 is an identifier identifying the name of the event log with there being 12 events—Event 1 to Event 12. Note that the value “Event ID” may not be present in an actual set of event log data but is used in the example for identifying event logs in the current disclosure. Accordingly, Event ID is a not a parameter involved in identifying identical event logs. The parameters for each event log include action 204, source 206, user 208, and time stamp 210. As mentioned above, the parameter time stamp 210 is not used in the determination of identical event logs. The values for time stamp 210 do indicate the time period for the accumulation of the event logs (from 09:01 for Event 1 to 09:58 for Event 12), which may be used for identification of the time period in the summary log, as described below.

In the illustrated embodiment, the action 204 values include “contact server”, “delete trash”, or “close”. The source 206 values include “email”, “web meeting”, or “music streaming”. User 208 values include “User A” or “User B”. Using the information illustrated in FIG. 2, identical event log determination module 140 may determine that event logs—Event 1, Event 4, Event 5, Event 6, Event 9, and Event 11—are identical event logs as each of these event logs has the same values for action 204, source 206, and user 208—“Contact server”, “email”, “User A”, respectively. Event 2 is different as the value for action 204 is different—“delete trash”. Event 3 is different as the value for source 206 is different—“web meeting”. Event 7 is different as the value of user 208 is different—“User B”. Event 8 is different as the value for source 206 is different—“web meeting” (note that Event 8 is, however, identical to Event 3, as mentioned below). Event 10 is different as the value for source 20 is different—“music streaming”. Event 12 is different as the value for action 204 is different—“close”.

Some embodiments may be contemplated where multiple event logs are identified as being identical when not all parameters in the event logs are identical. For instance, multiple event logs may be identified as being identical when one or more specified parameters have identical values and values of other non-specified parameter(s) can vary between event logs. As an example, embodiments may be contemplated where event logs are identical when the event logs have the same action (e.g., “contact server” in the example of FIG. 2) while other parameters (e.g., user or source) can have varying values.

Turning back to FIG. 1, identical event log determination module 140 may output identical event logs 142 to summary log generation module 150. Using the example embodiment of FIG. 2, summary log generation module 150 may receive indications that event logs associated with Event 1, Event 4, Event 5, Event 6, Event 9, and Event 11 are identical and event logs associated with Event 3 and Event 8 are identical. Summary log generation module 150 may implement these indications of identical event logs and along with information from the event logs to generate summary logs for the identical event logs.

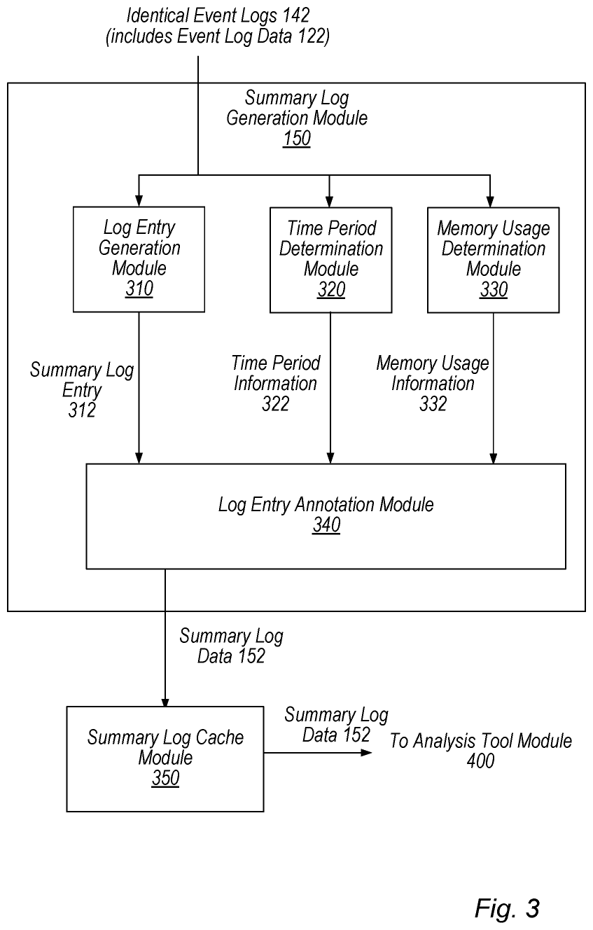

FIG. 3 is a block diagram of summary log generation module 150, according to some embodiments. In the illustrated embodiment, summary log generation module 150 includes log entry generation module 310, time period determination module 320, memory usage determination module 330, and log entry annotation module 340. In various embodiments, identical event logs 142 (along with event log data 122) is provided to log entry generation module 310, time period determination module 320, and memory usage determination module 330. Thus, each module receives information about identical event logs along with the event logs data itself.

In certain embodiments, log entry generation module 310 determines a summary log entry 312 for identical event logs. The summary log entry 312 may include the parameters from the event logs along with the values that are identical across the event logs. For instance, using the example of FIG. 2, the first summary log entry for identical events—1, 4, 5, 6, 9, 11—would list the action as “contact server”, the source as “email”, and the user as “User A”. Log entry generation module 310 may also generate a second summary log entry for identical events—3 and 8—that lists the action as “contact server”, the source as “web meeting”, and the user as “User A”. In some embodiments, summary log entries also include the number of events (e.g., incidences) that are identical. Thus, the first summary log entry may include an indication that there are six events that are identical with these values while the second summary log entry may include an indication that there are two events that are identical with these values. Table I below shows examples of the first summary log entry 312A and the second summary log entry 312B based on the information in the example of FIG. 2.

TABLE I

| Summary Log | | | | Number of |
|---|---|---|---|---|
| Entry ID | Action | Source | User | Events |
| 1^{st} Summary | Contact Server | Email | User A | 6 |
| Log Entry 312A | | | | |
| 2^{nd} Summary | Contact Server | Web Meeting | User A | 2 |
| Log Entry 312B | | | | |

Turning again to FIG. 3, time period determination module 320 may assess the information received in identical event logs 142 (along with event log data 122) and output time period information 322. In certain embodiments, time period information 322 is an indicator of the period of time over which the identical logs are accumulated. For example, with the data shown in FIG. 2, the time period that the event logs were accumulated went from 09:01 to 09:58. Thus, time period information 322 may provide an indication of that time period. For instance, time period information 322 may indicate that the event logs began at 09:01 with a time period length of 57 minutes. Alternatively, time period information 322 may simply indicate the start and end times of the time period.

In various embodiments, memory usage determination module 330 may assess the information received in identical event logs 142 (along with event log data 122) and output memory usage information 332. Memory usage information 332 may be an indication of the total memory associated with the identical event logs being summarized. For instance, if each of the six identical event logs for summary log entry 312A are 10 kb, then the total memory usage of the six identical event logs is 60 kb. This total memory usage may be output in the memory usage information 332.

As shown in FIG. 3, summary log entry 312, time period information 322, and memory usage information 332 are provided to log entry annotation module 340. In certain embodiments, log entry annotation module 340 takes the summary log entry 312 and annotates the summary log entry with the received time period information 322 and memory usage information 332. For instance, using the summary log entry information in TABLE I above and the information from the event logs of FIG. 2, annotated summary log entries may be created as shown in TABLE II below (assuming 10 kb memory usage per event log).

TABLE II

| Summary | | | | Number of | Time | Memory |
|---|---|---|---|---|---|---|
| Log Entry ID | Action | Source | User | Events | Period | Usage |
| 1^{st} Summary | Contact | Email | User A | 6 | 09:01-09:58 | 60 kb |
| Log Entry | Server | | | | | |
| 312A | | | | | | |
| 2^{nd} Summary | Contact | Web | User A | 2 | 09:01-09:58 | 20 kb |
| Log Entry | Server | Meeting | | | | |
| 312B | | | | | | |

The summary log entries, as shown in TABLE II, may be output by log entry annotation module 340 as summary log data 152, as shown in FIG. 3. It should be noted that the “time period” in the summary log entries is for the overall analyzed time period (e.g., the time period for all the event logs shown in FIG. 2). Embodiments may be contemplated where the time period for a summary log entry is determined based on the time frame of the actual identical event logs. For example, using the information in FIG. 2, the time period for second summary log entry 312B may be determined as 09:06-09:45 as that is the actual time period that elapses between the two event logs that are identical and summarized by the log entry.

While summary log generation module 150, as shown in FIG. 3, includes the annotation of time period information and memory usage information to summary log entries generated for summary log data 152, other summary information associated with the event logs may also be included in summary log data 152 as needed. For example, information about the time length of events (e.g., elapsed time period of event or how long event took) may be included in event logs or determined from event log information. In some contemplated embodiments, summary log data 152 may include average elapsed time period of events determined from the event length information or an indication of the span of elapsed time periods in the identical event logs (e.g., the events took anywhere between 1 and 2 seconds). In yet more contemplated embodiments, if an event that is otherwise identical to other events has a different elapsed time period (such as 10 seconds versus average of 1-2 seconds for other events), summary log data 152 may include an indication of the longer elapsed time period. For instance, the event having the longer elapsed time period may get its own unique log line in summary log data 152.

In some embodiments, as shown in FIG. 3, summary log data 152 is provided to summary log cache module 350. Summary log cache module 350 may be a memory cache or other storage associated with enterprise system 130, shown in FIG. 1. Summary log cache module 350 may serve as a cache that is accessible by an analysis tool (e.g., analysis tool module 400, shown in FIG. 4). In some embodiments, summary log cache module 350 transmits summary log data 152 to the analysis tool (e.g., via a network connection). Summary log cache module 350 provides a location for storing summary log entries as the summary log entries are generated. At various points, a summary log file may be generated from summary log entries stored in summary log cache module 350. The summary log file may be the file accessed (e.g., the summary log data 152 accessed) by the analysis tool. Thus, summary log cache module 350 provides a storage place for summary log entries before multiple summary log entries are accessed as a summary log file at a desired time by the analysis tool.

Various techniques may be contemplated to implement identical log determination module 140 and summary log generation module 150 for the identification of identical event logs and the summarization of the identical event logs. Certain embodiments are contemplated where one or both of identical log determination module 140 and summary log generation module 150 are implemented using simple mathematical models. For instance, a mathematical model may be used to determine whether values of specified parameters match 100% to identify identical event logs. Another mathematical model may then be implemented to generate a summary from the specified parameters identified as being identical. Other embodiments may be contemplated where machine learning models are implemented for one or both of identical log determination module 140 and summary log generation module 150. For instance, neural network models, decision tree models, or any rules-based algorithm models may be implemented to either individually perform the tasks of identical log determination module 140 and summary log generation module 150 or perform these tasks in combination (e.g., a single neural network model performs the tasks for both identical log determination module 140 and summary log generation module 150).

### Example Analysis Tool Module

FIG. 4 is a block diagram depicting an example analysis tool module, according to some embodiments. In the illustrated embodiment, analysis tool module 400 includes security tool module 410, development tool module 420, and information technology tool module 430. It should be noted that an analysis tool associated with enterprise system 130 may include any number of the tools illustrated in FIG. 4. In various embodiments, analysis tool module 400 (and its included tool modules 410, 420, or 430) are located remotely from enterprise system 130. For instance, analysis tool module 400 may be located on a server remote from enterprise system 130.

As shown in FIG. 4, each of security tool module 410, development tool module 420, and information technology tool module 430 is capable of receiving summary log data 152 from enterprise system 130. For instance, each module may be capable of accessing summary log data 152 from summary log cache module 350, shown in FIG. 3. As described above, summary log data 152 is a summary of event logs associated with enterprise system 130 that includes essentially all the information needed to make determinations by the analysis tools. Summary log data 152 provides this information in a compressed format that requires less computational processing and thus the analysis tools can be more efficient in providing the desired outputs, examples of which are described below. Using summary log data 152 that has minimal event log losses also allows analysis tools (such as the security tool) to able to fully process events that have occurred and provide more accurate analysis of the events while preventing the presence of security holes that can be exploited. Additionally, the financial cost of running these tools is reduced by only operating on summary log data 152 instead of the large volumes of event log data from which the summary log data is generated.

In various embodiments, security tool module 410 implements security operations for enterprise system 130. For example, security tool module 410 may be a SIEM tool module configured to detect and report anomalies in event log data recorded in enterprise system 130. As discussed above, security tool module 410 may be programmed to be capable of assessing summary log data 152 to determine whether abnormalities exist in event logs used to generate the summary log data. Output from security tool module 410 may, for example, include anomaly determination results 412, as shown in FIG. 4. In some embodiments, security tool module 410 may be capable of accessing (or requesting) full event log data when an anomaly is detected. Full event log data may be analyzed for further investigation of the anomaly and the causes of the anomaly once an anomaly is identified based on summary log data 152.

Development tool module 420 may, in some embodiments, be a tool used to develop further software tools implemented by enterprise system 130. For example, development tool module 420 may be used to analyze summary log data 152 to determine whether changes should be made in any software components in enterprise system 130. As a specific example, embodiments may be contemplated where development tool module 420 analyzes summary log data 152 and determines time periods (e.g., time intervals) to be implemented in the generation of summary logs. For instance, development tool module 420 may determine that identical log determination module 140 should access event logs more or less frequently based on analysis of summary log data 152. Accordingly, development tool module 420 may provide customization in the time intervals for the generation of summary log data according to the needs of enterprise system 130 and the customer associated with the enterprise system. Contemplated embodiments for development tool module 420 include the use of machine learning models assess summary log data 152 and output time interval recommendations 422 for summarizing log data in enterprise system 130.

Information technology tool module 430 may be implemented to provide analysis of operational errors in enterprise system 130. For example, information technology tool module 430 may be a tool utilized by information technology operators associated with enterprise system 130 (or a provider for the enterprise system) to determine root causes or other originations of operational errors within the enterprise system based on event log data. As shown in FIG. 4, root cause determination results 432 may be an output of information technology tool module 430 based on summary log data 152.

### Example Method

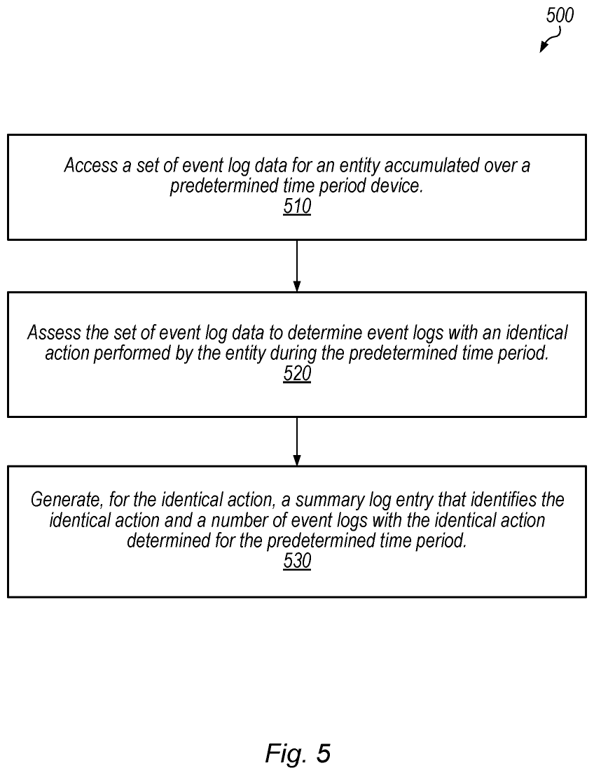

FIG. 5 is a flow diagram depicting an example method for generating a summary log entry for event logs recorded in an enterprise system, according to some embodiments. The method 500 shown in FIG. 5 may be used in conjunction with any of the computer circuitry, systems, devices, elements, or components disclosed herein, among other devices. In various embodiments, some of the method elements shown may be performed concurrently, in a different order than shown, or may be omitted. Additional method elements may also be performed as desired. In some embodiments, method 500 is performed by enterprise system 130.

At 510, in the illustrated embodiment, execution of the method includes accessing a set of event log data for an entity accumulated over a predetermined time period. In some embodiments, the entity is an enterprise system associated with a plurality of users. In some embodiments, the event log data is generated by an enterprise source associated with the enterprise system.

At 520, execution of the method includes assessing the set of event log data to determine event logs with an identical action performed by the entity during the predetermined time period.

At 530, execution of the method includes generating, for the identical action, a summary log entry that identifies the identical action and a number of event logs with the identical action determined for the predetermined time period. In some embodiments, the summary log entry is generated for the identical action being performed by an individual user from the plurality of users.

In some embodiments, the summary log entry includes an indication of the predetermined time period where the indication of the predetermined time period includes a length of the predetermined time period and a time and date stamp for the predetermined time period. In some embodiments, execution of the method includes determining a total memory size of the determined event logs with the identical action in the set of event log data and annotating the summary log entry with an indication of the total memory size.

In some embodiments, execution of the method includes assessing the set of event log data to determine event logs with a second identical action performed by the entity during the predetermined time period, the second identical action being a different action from the identical action and generating, for the second identical action, a second summary log entry that identifies the second identical action and a number of event logs with the second identical action determined for the predetermined time period. In some embodiments, execution of the method includes transmitting the summary log entry and the second summary log entry to a security tool configured to determine anomalies in the set of event log data.

### Exemplary Multi-Tenant Database System

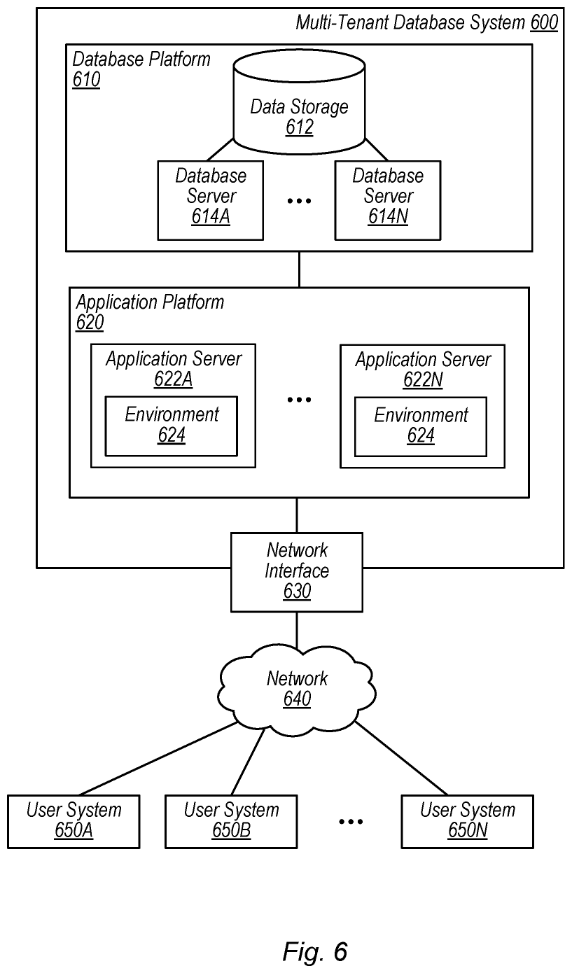

Turning now to FIG. 6, an exemplary multi-tenant database system (MTS) 600 in which various techniques of the present disclosure can be implemented is shown—e.g., system 100 may be MTS 600. In FIG. 6, MTS 600 includes a database platform 610, an application platform 620, and a network interface 630 connected to a network 640. Also as shown, database platform 610 includes a data storage 612 and a set of database servers 614A-N that interact with data storage 612, and application platform 620 includes a set of application servers 622A-N having respective environments 624. In the illustrated embodiment, MTS 600 is connected to various user systems 650A-N through network 640. The disclosed multi-tenant system is included for illustrative purposes and is not intended to limit the scope of the present disclosure. In other embodiments, techniques of this disclosure are implemented in non-multi-tenant environments such as client/server environments, cloud computing environments, clustered computers, etc.

MTS 600, in various embodiments, is a set of computer systems that together provide various services to users (alternatively referred to as “tenants”) that interact with MTS 600. In some embodiments, MTS 600 implements a customer relationship management (CRM) system that provides mechanism for tenants (e.g., companies, government bodies, etc.) to manage their relationships and interactions with customers and potential customers. For example, MTS 600 might enable tenants to store customer contact information (e.g., a customer's website, email address, telephone number, and social media data), identify opportunities, record service issues, and manage marketing campaigns. MTS 600 may also enable those tenants to identify how customers have been communicated with, what the customers have bought, when the customers last purchased items, and what the customers paid. To provide the services of a CRM system and/or other services, as shown, MTS 600 includes a database platform 610 and an application platform 620.

Database platform 610, in various embodiments, is a combination of hardware elements and software routines that implement database services for storing and managing data of MTS 600, including tenant data. As shown, database platform 610 includes data storage 612. Data storage 612, in various embodiments, includes a set of storage devices (e.g., solid state drives, hard disk drives, etc.) that are connected together on a network (e.g., a storage attached network (SAN)) and configured to redundantly store data to prevent data loss. In various embodiments, data storage 612 is used to implement a database comprising a collection of information that is organized in a way that allows for access, storage, and manipulation of the information. Data storage 612 may implement a single database, a distributed database, a collection of distributed databases, a database with redundant online or offline backups or other redundancies, etc. As part of implementing the database, data storage 612 may store files (e.g., files storing event log data 122) that include one or more database records having respective data payloads (e.g., values for fields of a database table) and metadata (e.g., a key value, timestamp, table identifier of the table associated with the record, tenant identifier of the tenant associated with the record, etc.).

In various embodiments, a database record may correspond to a row of a table. A table generally contains one or more data categories that are logically arranged as columns or fields in a viewable schema. Accordingly, each record of a table may contain an instance of data for each category defined by the fields. For example, a database may include a table that describes a customer with fields for basic contact information such as name, address, phone number, fax number, etc. A record therefore for that table may include a value for each of the fields (e.g., a name for the name field) in the table. Another table might describe a purchase order, including fields for information such as customer, product, sale price, date, etc. In various embodiments, standard entity tables are provided for use by all tenants, such as tables for account, contact, lead and opportunity data, each containing pre-defined fields. MTS 600 may store, in the same table, database records for one or more tenants—that is, tenants may share a table. Accordingly, database records, in various embodiments, include a tenant identifier that indicates the owner of a database record. As a result, the data of one tenant is kept secure and separate from that of other tenants so that that one tenant does not have access to another tenant's data, unless such data is expressly shared.

In some embodiments, the data stored at data storage 612 is organized as part of a log-structured merge-tree (LSM tree—e.g., enterprise system 130 may implement an LSM tree). An LSM tree normally includes two high-level components: an in-memory buffer and a persistent storage. In operation, a database server 614 may initially write database records into a local in-memory buffer before later flushing those records to the persistent storage (e.g., data storage 612). As part of flushing database records, the database server 614 may write the database records into new files that are included in a “top” level of the LSM tree. Over time, the database records may be rewritten by database servers 614 into new files included in lower levels as the database records are moved down the levels of the LSM tree. In various implementations, as database records age and are moved down the LSM tree, they are moved to slower and slower storage devices (e.g., from a solid state drive to a hard disk drive) of data storage 612.

When a database server 614 wishes to access a database record for a particular key, the database server 614 may traverse the different levels of the LSM tree for files that potentially include a database record for that particular key. If the database server 614 determines that a file may include a relevant database record, the database server 614 may fetch the file from data storage 612 into a memory of the database server 614. The database server 614 may then check the fetched file for a database record having the particular key. In various embodiments, database records are immutable once written to data storage 612. Accordingly, if the database server 614 wishes to modify the value of a row of a table (which may be identified from the accessed database record), the database server 614 writes out a new database record to the top level of the LSM tree. Over time, that database record is merged down the levels of the LSM tree. Accordingly, the LSM tree may store various database records for a database key where the older database records for that key are located in lower levels of the LSM tree then newer database records.

Database servers 614, in various embodiments, are hardware elements, software routines, or a combination thereof capable of providing database services, such as data storage, data retrieval, and/or data manipulation. A database server 614 may correspond to database node executed as part of a plurality of database nodes that make up a database. Such database services may be provided by database servers 614 to components (e.g., application servers 622) within MTS 600 and to components external to MTS 600. As an example, a database server 614 may receive a database transaction request from an application server 622 that is requesting data to be written to or read from data storage 612. The database transaction request may specify an SQL SELECT command to select one or more rows from one or more database tables. The contents of a row may be defined in a database record and thus database server 614 may locate and return one or more database records that correspond to the selected one or more table rows. In various cases, the database transaction request may instruct database server 614 to write one or more database records for the LSM tree—database servers 614 maintain the LSM tree implemented on database platform 610. In some embodiments, database servers 614 implement a relational database management system (RDMS) or object oriented database management system (OODBMS) that facilitates storage and retrieval of information against data storage 612. In various cases, database servers 614 may communicate with each other to facilitate the processing of transactions. For example, database server 614A may communicate with database server 614N to determine if database server 614N has written a database record into its in-memory buffer for a particular key.

Application platform 620, in various embodiments, is a combination of hardware elements and software routines that implement and execute CRM software applications as well as provide related data, code, forms, web pages and other information to and from user systems 650 and store related data, objects, web page content, and other tenant information via database platform 610. In order to facilitate these services, in various embodiments, application platform 620 communicates with database platform 610 to store, access, and manipulate data. In some instances, application platform 620 may communicate with database platform 610 via different network connections. For example, one application server 622 may be coupled via a local area network and another application server 622 may be coupled via a direct network link. Transfer Control Protocol and Internet Protocol (TCP/IP) are exemplary protocols for communicating between application platform 620 and database platform 610, however, it will be apparent to those skilled in the art that other transport protocols may be used depending on the network interconnect used.

Application servers 622, in various embodiments, are hardware elements, software routines, or a combination thereof capable of providing services of application platform 620, including processing requests received from tenants of MTS 600. Application servers 622, in various embodiments, can spawn environments 624 that are usable for various purposes, such as providing functionality for developers to develop, execute, and manage applications (e.g., business logic). Data may be transferred into an environment 624 from another environment 624 and/or from database platform 610. In some cases, environments 624 cannot access data from other environments 624 unless such data is expressly shared. In some embodiments, multiple environments 624 can be associated with a single tenant.

Application platform 620 may provide user systems 650 access to multiple, different hosted (standard and/or custom) applications, including a CRM application and/or applications developed by tenants. In various embodiments, application platform 620 may manage creation of the applications, testing of the applications, storage of the applications into database objects at data storage 612, execution of the applications in an environment 624 (e.g., a virtual machine of a process space), or any combination thereof. In some embodiments, application platform 620 may add and remove application servers 622 from a server pool at any time for any reason, there may be no server affinity for a user and/or organization to a specific application server 622. In some embodiments, an interface system (not shown) implementing a load balancing function (e.g., an F5 Big-IP load balancer) is located between the application servers 622 and the user systems 650 and is configured to distribute requests to the application servers 622. In some embodiments, the load balancer uses a least connections algorithm to route user requests to the application servers 622. Other examples of load balancing algorithms, such as are round robin and observed response time, also can be used. For example, in certain embodiments, three consecutive requests from the same user could hit three different servers 622, and three requests from different users could hit the same server 622.

In some embodiments, MTS 600 provides security mechanisms, such as encryption, to keep each tenant's data separate unless the data is shared. If more than one server 614 or 622 is used, they may be located in close proximity to one another (e.g., in a server farm located in a single building or campus), or they may be distributed at locations remote from one another (e.g., one or more servers 614 located in city A and one or more servers 622 located in city B). Accordingly, MTS 600 may include one or more logically and/or physically connected servers distributed locally or across one or more geographic locations.

One or more users (e.g., via user systems 650) may interact with MTS 600 via network 640. User system 650 may correspond to, for example, a tenant of MTS 600, a provider (e.g., an administrator) of MTS 600, or a third party. Each user system 650 may be a desktop personal computer, workstation, laptop, PDA, cell phone, or any Wireless Access Protocol (WAP) enabled device or any other computing device capable of interfacing directly or indirectly to the Internet or other network connection. User system 650 may include dedicated hardware configured to interface with MTS 600 over network 640. User system 650 may execute a graphical user interface (GUI) corresponding to MTS 600, an HTTP client (e.g., a browsing program, such as Microsoft's Internet Explorer™ browser, Netscape's Navigator™ browser, Opera's browser, or a WAP-enabled browser in the case of a cell phone, PDA or other wireless device, or the like), or both, allowing a user (e.g., subscriber of a CRM system) of user system 650 to access, process, and view information and pages available to it from MTS 600 over network 640. Each user system 650 may include one or more user interface devices, such as a keyboard, a mouse, touch screen, pen or the like, for interacting with a graphical user interface (GUI) provided by the browser on a display monitor screen, LCD display, etc. in conjunction with pages, forms and other information provided by MTS 600 or other systems or servers. As discussed above, disclosed embodiments are suitable for use with the Internet, which refers to a specific global internetwork of networks. It should be understood, however, that other networks may be used instead of the Internet, such as an intranet, an extranet, a virtual private network (VPN), a non-TCP/IP based network, any LAN or WAN or the like.

Because the users of user systems 650 may be users in differing capacities, the capacity of a particular user system 650 might be determined one or more permission levels associated with the current user. For example, when a user is using a particular user system 650 to interact with MTS 600, that user system 650 may have capacities (e.g., user privileges) allotted to that user. But when an administrator is using the same user system 650 to interact with MTS 600, the user system 650 may have capacities (e.g., administrative privileges) allotted to that administrator. In systems with a hierarchical role model, users at one permission level may have access to applications, data, and database information accessible by a lower permission level user, but may not have access to certain applications, database information, and data accessible by a user at a higher permission level. Thus, different users may have different capabilities with regard to accessing and modifying application and database information, depending on a user's security or permission level. There may also be some data structures managed by MTS 600 that are allocated at the tenant level while other data structures are managed at the user level.

In some embodiments, a user system 650 and its components are configurable using applications, such as a browser, that include computer code executable on one or more processing elements. Similarly, in some embodiments, MTS 600 (and additional instances of MTSs, where more than one is present) and their components are operator configurable using application(s) that include computer code executable on processing elements. Thus, various operations described herein may be performed by executing program instructions stored on a non-transitory computer-readable medium and executed by processing elements. The program instructions may be stored on a non-volatile medium such as a hard disk, or may be stored in any other volatile or non-volatile memory medium or device as is well known, such as a ROM or RAM, or provided on any media capable of staring program code, such as a compact disk (CD) medium, digital versatile disk (DVD) medium, a floppy disk, and the like. Additionally, the entire program code, or portions thereof, may be transmitted and downloaded from a software source, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing aspects of the disclosed embodiments can be implemented in any programming language that can be executed on a server or server system such as, for example, in C, C+, HTML, Java, JavaScript, or any other scripting language, such as VBScript.

Network 640 may be a LAN (local area network), WAN (wide area network), wireless network, point-to-point network, star network, token ring network, hub network, or any other appropriate configuration. The global internetwork of networks, often referred to as the “Internet” with a capital “I,” is one example of a TCP/IP (Transfer Control Protocol and Internet Protocol) network. It should be understood, however, that the disclosed embodiments may utilize any of various other types of networks.

User systems 650 may communicate with MTS 600 using TCP/IP and, at a higher network level, use other common Internet protocols to communicate, such as HTTP, FTP, AFS, WAP, etc. For example, where HTTP is used, user system 650 might include an HTTP client commonly referred to as a “browser” for sending and receiving HTTP messages from an HTTP server at MTS 600. Such a server might be implemented as the sole network interface between MTS 600 and network 640, but other techniques might be used as well or instead. In some implementations, the interface between MTS 600 and network 640 includes load sharing functionality, such as round-robin HTTP request distributors to balance loads and distribute incoming HTTP requests evenly over a plurality of servers.

In various embodiments, user systems 650 communicate with application servers 622 to request and update system-level and tenant-level data from MTS 600 that may require one or more queries to data storage 612. In some embodiments, MTS 600 automatically generates one or more SQL statements (the SQL query) designed to access the desired information. In some cases, user systems 650 may generate requests having a specific format corresponding to at least a portion of MTS 600. As an example, user systems 650 may request to move data objects into a particular environment 624 using an object notation that describes an object relationship mapping (e.g., a JavaScript object notation mapping) of the specified plurality of objects.

### Exemplary Computer System

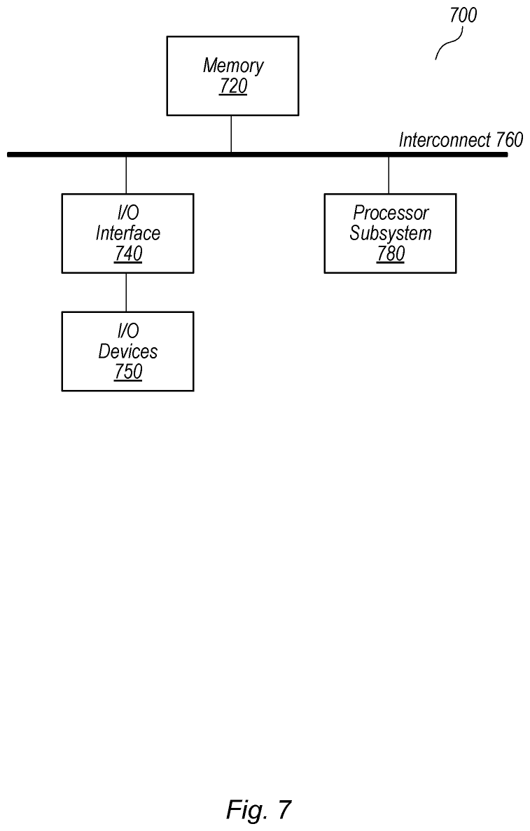

Turning now to FIG. 7, a block diagram of an exemplary computer system 700, which may implement system 100, enterprise system 130, event log data module 120, MTS 600, and/or user system 650, is depicted. Computer system 700 includes a processor subsystem 780 that is coupled to a system memory 720 and I/O interfaces(s) 740 via an interconnect 760 (e.g., a system bus). I/O interface(s) 740 is coupled to one or more I/O devices 750. Although a single computer system 700 is shown in FIG. 7 for convenience, system 700 may also be implemented as two or more computer systems operating together.

Processor subsystem 780 may include one or more processors or processing units. In various embodiments of computer system 700, multiple instances of processor subsystem 780 may be coupled to interconnect 760. In various embodiments, processor subsystem 780 (or each processor unit within 780) may contain a cache or other form of on-board memory.

System memory 720 is usable store program instructions executable by processor subsystem 780 to cause system 700 to perform various operations described herein. System memory 720 may be implemented using different physical memory media, such as hard disk storage, floppy disk storage, removable disk storage, flash memory, random access memory (RAM-SRAM, EDO RAM, SDRAM, DDR SDRAM, RAMBUS RAM, etc.), read only memory (PROM, EEPROM, etc.), and so on. Memory in computer system 700 is not limited to primary storage such as memory 720. Rather, computer system 700 may also include other forms of storage such as cache memory in processor subsystem 780 and secondary storage on I/O Devices 750 (e.g., a hard drive, storage array, etc.). In some embodiments, these other forms of storage may also store program instructions executable by processor subsystem 780. In some embodiments, program instructions that when executed implement enterprise system 130 may be included/stored within system memory 720.

I/O interfaces 740 may be any of various types of interfaces configured to couple to and communicate with other devices, according to various embodiments. In one embodiment, I/O interface 740 is a bridge chip (e.g., Southbridge) from a front-side to one or more back-side buses. I/O interfaces 740 may be coupled to one or more I/O devices 750 via one or more corresponding buses or other interfaces. Examples of I/O devices 750 include storage devices (hard drive, optical drive, removable flash drive, storage array, SAN, or their associated controller), network interface devices (e.g., to a local or wide-area network), or other devices (e.g., graphics, user interface devices, etc.). In one embodiment, computer system 700 is coupled to a network via a network interface device 750 (e.g., configured to communicate over Wi-Fi, Bluetooth, Ethernet, etc.).

The present disclosure includes references to “embodiments,” which are non-limiting implementations of the disclosed concepts. References to “an embodiment,” “one embodiment,” “a particular embodiment,” “some embodiments,” “various embodiments,” and the like do not necessarily refer to the same embodiment. A large number of possible embodiments are contemplated, including specific embodiments described in detail, as well as modifications or alternatives that fall within the spirit or scope of the disclosure. Not all embodiments will necessarily manifest any or all of the potential advantages described herein.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” or is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation-[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of task or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

What is claimed is:

1. A method, comprising:
accessing, by a computer system, a set of event log data for an entity accumulated over a predetermined time period;
assessing the set of event log data to determine event logs with an identical action performed by the entity during the predetermined time period; and
generating, for the identical action, a summary log entry that identifies the identical action and a number of event logs with the identical action determined for the predetermined time period.

2. The method of claim 1, wherein the summary log entry includes an indication of the predetermined time period, wherein the indication of the predetermined time period includes a length of the predetermined time period and a time and date stamp for the predetermined time period.

3. The method of claim 1, further comprising:
determining a total memory size of the determined event logs with the identical action in the set of event log data; and
annotating the summary log entry with an indication of the total memory size.

4. The method of claim 1, wherein the entity is an enterprise system associated with a plurality of users.

5. The method of claim 4, wherein the event log data is generated by an enterprise source associated with the enterprise system.

6. The method of claim 5, wherein the summary log entry is generated for the identical action being performed by an individual user from the plurality of users.

7. The method of claim 6, wherein the summary log entry identifies the enterprise source and the individual user along with the identical action and the number of event logs with the identical action.

8. The method of claim 1, further comprising:
assessing the set of event log data to determine event logs with a second identical action performed by the entity during the predetermined time period, the second identical action being a different action from the identical action; and
generating, for the second identical action, a second summary log entry that identifies the second identical action and a number of event logs with the second identical action determined for the predetermined time period.

9. The method of claim 8, further comprising transmitting the summary log entry and the second summary log entry to a security tool configured to determine anomalies in the set of event log data.

10. A non-transitory computer-readable medium having instructions stored thereon that are capable of causing an enterprise system to implement operations comprising:
accessing a set of event log data for an enterprise system accumulated over a predetermined time period;
assessing the set of event log data to determine event logs having an identical action associated with an identical enterprise source performed by an identical user during the predetermined time period; and
generating, for the event logs having the identical action associated with the identical enterprise source performed by the identical user, a summary log entry that identifies the identical action, the identical enterprise source, the identical user, and a number of event logs determined for the predetermined time period.

11. The non-transitory computer-readable medium of claim 10, wherein the summary log entry includes an indication of the predetermined time period, wherein the indication of the predetermined time period includes a length of the predetermined time period and a time and date stamp for the predetermined time period.

12. The non-transitory computer-readable medium of claim 10, further comprising:
determining a total memory size of the determined event logs having the identical action performed by the identical user on the identical enterprise source in the set of event log data; and
annotating the summary log entry with an indication of the total memory size.

13. The non-transitory computer-readable medium of claim 10, wherein the enterprise source is either an enterprise software source or an enterprise hardware source associated with the enterprise system.

14. The non-transitory computer-readable medium of claim 10, further comprising caching the summary log entry in a summary log file associated with the enterprise system.

15. The non-transitory computer-readable medium of claim 10, wherein the instructions stored thereon are capable of causing the enterprise system to implement operations comprising.
assessing the set of event log data to determine additional event logs that have an identical action associated with an identical enterprise source performed by an identical user during the predetermined time period;
generating, for each identical action associated with an identical enterprise source performed by an identical user, a summary log entry that identifies the identical action, the identical enterprise source, and the identical user along with a number of event logs determined for the predetermined time period;
generating a summary log file with all the generated summary log entries; and
transmitting the summary log file to a security tool configured to determine anomalies in the set of event log data.

16. A system, comprising:
at least one processor; and
a memory having instructions stored thereon that are executable by the at least one processor to cause the system to generate a summary log entry for multiple events, including:
accessing a set of event log data for an enterprise source accumulated over a predetermined time period;
assessing the set of event log data to determine event logs of a same action performed by a same user during the predetermined time period; and
generating, for the same action performed by the same user, a summary log entry that identifies the same action, the same user, and a number of the event logs of the same action performed by the same user during the predetermined time period.

17. The system of claim 16, wherein the summary log entry includes an indication of the predetermined time period, and wherein the indication of the predetermined time period includes a length of the predetermined time period and a time and date stamp for the predetermined time period.

18. The system of claim 16, wherein the instructions are executable by the at least one processor to further cause the system to:
determine a total memory size of the determined event logs of the same action performed by the same user in the set of event log data; and
annotate the summary log entry with an indication of the total memory size.

19. The system of claim 16, wherein the event log data is generated by the enterprise source in response to actions performed by users of an enterprise system.

20. The system of claim 16, wherein the summary log entry identifies the enterprise source along with the same action, the same user, and the number of the event logs.
